(19) United States
(12) Patent Application Publication
(10) Pub. No.: US 2012/0010809 A1
(43) Pub. Date: Jan. 12, 2012

(54) NAVIGATIONAL UNIT AND SYSTEM FOR MAINTAINING PHYSICAL ACTIVITY GOAL

(75) Inventors: Wilhelmus Johannes Joseph Stut, Eindhoven (NL); Ronaldus Maria Aarts, Eindhoven (NL); Rob Udink, Eindhoven (NL)

(73) Assignee: KONINKLIJKE PHILIPS ELECTRONICS N.V., EINDHOVEN (NL)

(21) Appl. No.: 13/131,135

(22) PCT Filed: Nov. 27, 2009
(86) PCT No.: PCT/IB2009/055381

§ 371 Date: Sep. 20, 2011

(30) Foreign Application Priority Data
Dec. 3, 2008 (EP) 08170542.8

(51) Int. Cl. G01C 21/00

(52) U.S. Cl. 701/465; 701/408

(57) ABSTRACT

The invention relates to a navigational unit 10 and a navigational device 50 for providing suggestions for switching mode of transportation. This may be used e.g. for suggesting car drivers to park at a reasonable distance of their destination such that the last part of their trip can be walked or cycled. By using information on a personal activity goal, performed activity, and possibly desired arrival time, a feasible and tailored suggestion can be given. In this way the time for transport and physical activity may be balanced.

### FIELD OF THE INVENTION

The present invention relates to a navigational unit for providing directions on how to navigate to a destination. The invention moreover relates to a navigational device, a route planner system and a method for navigating to a destination as well as a computer program product.

### BACKGROUND OF THE INVENTION

A navigation apparatus typically comprises a storage unit for storing map information as well as a position detector for detecting the current position, e.g. a GPS receiver. Map data and data on the current position may be used for providing directions to a specific destination. Typically, such directions are based on the fastest way to go to the specific destination.

US 2005/0021227 A1 describes a navigation apparatus. When a vehicle is traveling along a route toward a parking lot located near a destination facility, if traffic congestion along the route is detected, the navigation apparatus searches for an alternative parking lot that allows a user to reach the destination facility earlier than can by using the original parking lot. If such an alternative parking lot is detected, the predicted driving time and the predicted walking time are displayed together with a route to the parking lot. When traffic congestion is encountered when transporting a passenger by vehicle, the navigation apparatus determines a quicker way for the passenger to reach the destination facility. If the navigation apparatus detects that the passenger can reach the destination facility earlier if the passenger disembarks the vehicle and walks to the destination facility, the navigation apparatus presents information indicating a best point at which the passenger should disembark the vehicle.

### SUMMARY OF THE INVENTION

It may be seen as an object of the present invention to provide an alternative navigational unit and navigational system.

This object and several other objects are obtained in a first aspect of the invention by providing a navigational unit for providing directions on how to navigate to a destination, where the navigational unit is arranged to receive position information relating to the actual position of the navigational unit. The navigational unit is furthermore arranged for providing a suggestion on a location for switching from an existing mode of transport to a second mode of transport, where the suggestion is determined on the basis of a physical activity goal of a user and a calculation of the physical activity to be performed by the user at the existing mode of transport and/or at the second mode of transport in moving to the destination. Thus, instead of only taking the time for transportation into account, the inventive navigational unit takes the physical activity to be performed by the user at different mode of transport into account. Typically, either the existing or the second mode of transport is one wherein the user performs physical activity, such as walking or biking, and the other mode of transport is one wherein the user does not perform any significant physical activity, such as being a passenger in a bus or driving in a car. The suggestion on a location for switching may be determined at the navigational unit itself or at a separate device, such as a web server, for transferral to the navigational unit and subsequent display to a user.

Physical activity has been shown to be very beneficial for the health and wellbeing of people. Regular moderate physical activity improves one's general physical health; decreases the risk of medical conditions such as coronary artery diseases, diabetes, osteoporosis, and hypertension; reduces mental health concerns such as depression; can reduce the likelihood of falls; and plays a role in the maintenance of cognitive vitality in older age (see Newson R S, Kemps E B. Factors that promote and prevent exercise engagement in older adults. J Aging Health, 2007 June; 19(3):470-81).

Unfortunately many people are not physically active enough. For example, in 1997 in the USA only 15 percent of adults aged 18 years and older engaged in moderate physical activity for at least 30 minutes 5 or more days per week (see Healthy People 2010, Physical Activity and Fitness, Vol. 22).

The navigational unit is particularly, but not exclusively, advantageous for encouraging physical activity by providing suggestions for switching mode of transport when taking the physical activity of a user into account. Thus, the navigational unit may obtain information on the physical activity goal of a user and provide suggestions for switching mode of transport, taking the physical activity goal into account. Lack of time is a normal excuse for not being physically active, and the navigational unit is advantageous for encouraging using transport time for physical activity.

The location for switching mode of transport may e.g. be a location for parking a car, a bus stop for getting on/off a bus, a station for getting on/off a train, a location for parking a bicycle and start walking, etc.

According to an aspect of the navigational unit, the calculation of the physical activity to be performed takes into account the physical activity to be performed by a user, at the existing mode of transport, until the suggested location for switching mode of transport and the physical activity to be performed by the user, at the second mode of transport, from the suggested location for switching mode of transport to the destination.

The physical activity goal obtained by the navigational unit may be indicated in energy consumption or in time duration. The physical activity goal may e.g. by 30 minutes per day or an amount of kilocalories to be used by physical activity.

According to another aspect, the navigational unit may be arranged for receiving a signal from an activity monitor arranged for monitoring the physical activity of a user. Such an activity monitor may comprise a step monitor or heart rate monitor, providing more detailed information on the physical activity performed by the user. The signal from the activity monitor may comprise a summary of the physical activity performed during a span of time. The information on the physical activity might come from web based services, GPS information from the navigational unit itself. Moreover, the suggestion may be determined within the navigational unit itself or at a separate web server for subsequent transferral to the navigational unit.

According to a further aspect of the navigational unit, the suggestion on a location for switching is determined on the basis of a desired arrival time at the destination. Moreover, the average time of moving by the existing and second mode of transport may be taken into account, and the unit may further comprise a time calculation unit for calculating the predicted transportation time to the switching location and the predicted activity time.

According to yet a further aspect of the navigational unit, the suggestion on a location for switching is determined on the basis of a desired amount of physical activity to be performed by a user. Information of physical activity already performed on a specific day or within a specific span of time may also be taken into account in order to specify any remaining activity time for the user. Thus, the navigational unit may be arranged for providing suggestions where the time used for or the energy used by physical activity is as close as possible to the personal activity goal of a user.

According to a further aspect of the navigational unit, the suggestion on a location for switching is determined on the basis of a special route to be covered by the user in moving to the destination at the second mode of transport. Such a special route may be a scenic route and/or a route possible by the second mode of transport, but not the existing mode of transport.

According to a further aspect, the existing mode of transport is driving a car and said location for switching is a parking lot. Alternatively, the existing mode of transport is a means of public transportation and said location for switching is a stop for the means of public transportation, such as a bus stop, tram stop, a train station. Typically, the physical activity during a car ride or transport by bus, tram or train may be set to zero.

A second aspect of the invention relates to a navigational device, comprising a navigational unit, a storage medium and a satellite navigational module.

A third aspect of the invention relates to a route planner system for navigating to a destination, comprising a navigational device according to the invention and a personal activity program module.

A fourth aspect of the invention relates to a method of navigating to a destination, comprising the steps of receiving position information relating to the actual position of a user; receiving information on a physical activity goal of a user; determining the physical activities performed by a user; calculating the physical activity to be performed by a user at the existing mode of transport and the second mode of transport in moving to the destination; and providing a suggestion on a location for switching from the existing mode of transport to the second mode of transport on the basis of the previous steps.

In a fifth aspect, the invention relates to a computer program product being adapted to enable a computer system comprising at least one computer having data storage means associated therewith to control an navigational unit according to the first aspect of the invention.

This aspect of the invention is particularly, but not exclusively, advantageous in that the present invention may be implemented by a computer program product enabling a computer system to perform the operations of the fourth aspect of the invention. Thus, it is contemplated that some known navigational apparatus may be changed to operate according to the present invention by installing a computer program product on a computer system controlling the navigational unit. Such a computer program product may be provided on any kind of computer readable medium, e.g. magnetically or optically based medium, or through a computer based network, e.g. the Internet.

The first, second, third, fourth and fifth aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where:

FIG. 1 is a schematic drawing of a navigational device according to the invention,

FIG. 2 is a schematic drawing of a rout planner system according to the invention, and

FIG. 3 is a flow-chart of a method according to the invention.

### DETAILED DESCRIPTION OF AN EMBODIMENT

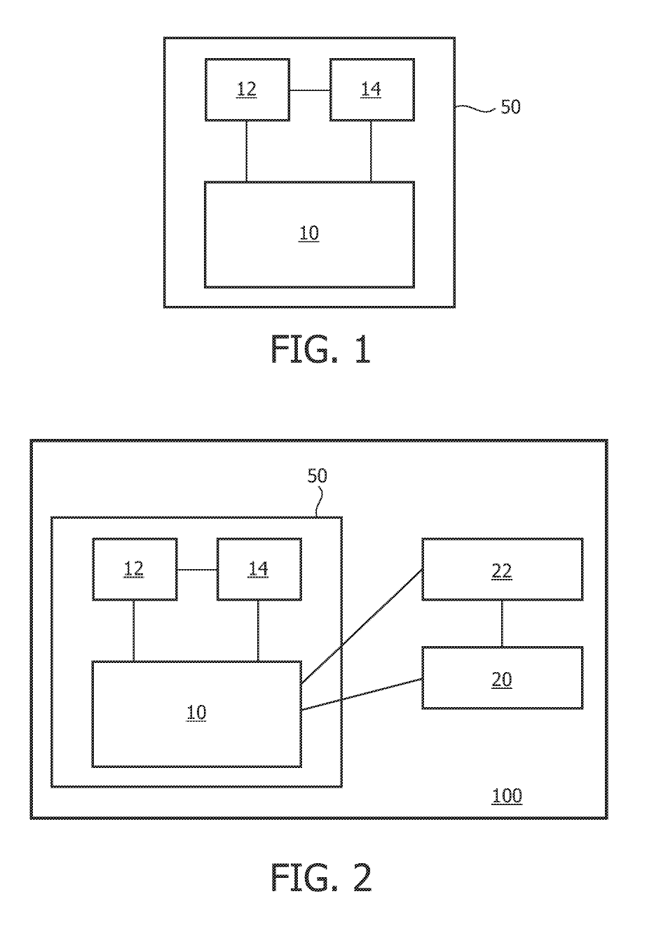

FIG. 1 is a schematic drawing of a navigational device 50 according to the invention. The navigational device 50 comprises a navigational unit 10 according to the invention. Apart from the navigational unit 10, the navigational device 50 comprises a storage medium 12 and a satellite navigational module 14, such as a GPS receiver. The storage medium 12 may be comprise a database with map information as well as storage for storing information on destination, preferred routes, former destinations, etc. The navigational device 50 may also comprise user interface means (not shown), such as a display and loudspeaker for outputting information and input means, such as a keyboard, key pad, touch screen, etc. The navigational device 50 also comprise energy means (not shown), such as a battery or other power source and/or connection to a source of electrical energy.

In the following the navigational unit 10 being part of the navigational device 50 will be described in detail.

The navigational unit 10 is arranged to receive position information relating to the actual position of the navigational unit, e.g. from the navigational module 14. Moreover, the navigational unit 10 is arranged for receiving information on a physical activity goal of a user, typically via some input means (not shown in FIG. 1).

The navigational unit is arranged for obtaining information on the existing mode of transport and for providing a suggestion on a location for switching from an existing mode of transport to a second mode of transport. This suggestion is determined on the basis of a physical activity goal of a user and a calculation of the physical activity to be performed by the user at the existing mode of transport and the second mode of transport in moving to the destination. The determination of the suggestion may also take the physical activity already performed by the user into account.

As an example, the existing mode of transport is driving in a car and the second mode of transport is walking by foot. The calculation of the physical activity to be performed takes into account the physical activity to be performed by a user when driving the car until the suggested location for switching to walking, e.g. a suggested location for parking, as well as the physical activity to be performed by the user when walking from the location for parking to the destination. The physical activity goal is typically indicated in energy consumption or in time duration, and the determined physical activity to be performed by the user when walking from the location for parking to the destination may be calculated in time or energy consumption in order to be readily comparable to the goal.

The navigational unit moreover is arranged for receiving a signal from an activity monitor 22 (see FIG. 2) arranged for monitoring the physical activity of a user in order to obtain more precise indications of the actual physical activity performed by the user.

Advantageously, the navigational unit 10 provides the suggestion on a location for switching on the basis of a desired arrival time at the destination. Alternatively, the suggestion on a location for switching may be determined on the basis of a desired amount of physical activity to be performed by a user.

Typically, lack of time is mentioned as one of the reasons of people for not doing regular physical activity. People have busy schedules, and apparently consider it difficult to plan or find a time slot for physical activity. The navigational unit is arranged for suggesting a parking spot which is situated at a reasonable distance of a destination of a car driver, such that the last part of the trip to the destination can be walked. By using a personal activity goal, performed activity, and possibly desired arrival time, a feasible and tailored advice can be given. In this way the time for transportation and physical activity may be balanced. The suggestion of the navigational unit for a parking spot may also take into account a special route to be covered by the user in walking to the destination, such as a scenic route. The suggestion may also take into account the activity needed for the return trip.

FIG. 2 is a schematic drawing of a route planner system 100 according to the invention. The route planner system 100 comprises a navigational device 50 according to the invention, for example the navigational device 50 described in accordance with FIG. 1. The route planner system 100 moreover comprises an activity monitor 22 or a step monitor or pedometer, and a personal activity program module 20. The personal activity program module 20 may set a daily activity goal for a user and may be arranged to measure the amount of activity performed by means input from the activity monitor 22. For example, a goal may be to do 30 minutes of moderate physical activity, such as brisk walking, per day. The activity monitor knows exactly which part of this goal has already been reached, and what remains to be done, viz. a Remaining Activity Duration.

The activity monitor 22 communicates the Remaining Activity Duration to the user's navigational device 50. For example, when entering his car, the user's activity monitor 22 may establish a wireless connection with the navigational device 50, and send the Remaining Activity Duration for that day.

Once the user has entered his destination into the navigational device 50, the navigational device 50 uses the Remaining Activity Duration to find a parking spot which is situated at a reasonable distance of this destination such that the last part of the trip can be walked. For example, the following algorithm may be used:

### 1. Determine Walking Distance:

Walking Distance=Remaining Activity Duration/Walking Speed

### Example:

Remaining Activity Duration=18 min,

Walking Speed=6 km/hr=10 min/km

Walking Distance=18 min/(10 min/km)=1.8 km

2. Suggest a location for parking at the Walking Distance from the destination or closer. Information on parking spots is part of state-of-the-art navigational devices.
3. Indicate the located parking spot and encourage the driver to park his car at that spot and walk the last part of the trip such that he/she will easily reach his/her daily goal of physical activity.

The algorithm can be refined by also using the desired arrival time. Based on maximum allowed driving speed and traffic conditions, state-of-the-art navigational devices are already able to predict a car's arrival time at a destination. When assuming a constant driving and walking speed, at any moment the Walking Distance can be determined on the fly using the following formula, such that the user arrives timely at the destination:

$$\frac{( RemainingDistance - WalkingDistance )}{DrivingSpeed} + \frac{WalkingDistance}{WalkingSpeed} = RemainingTime$$

where:

Remaining Distance is the total remaining distance to the destination by driving and walking Remaining Time is amount of time to the desired arrival time

### Example:

Driving Speed=60 km/hr

Walking Speed=6 km/hr

Remaining Distance=20 km

Remaining Time=0.5 hr

then Walking Distance becomes 1.11 km corresponding to 11.1 minutes of walking

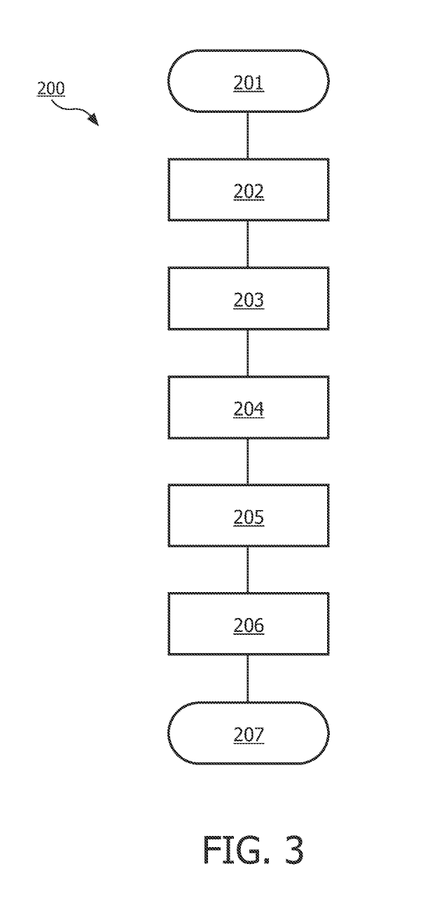

FIG. 3 is a flow-chart of a method 200 according to the invention. The method 200 starts at 201 and continues to the step 202 of receiving position information relating to the actual position of a user. This position information may be obtained from a GPS receiver. In step 203, information on a physical activity goal of a user is obtained, e.g. from a personal activity program module 20 (see FIG. 2). In subsequent step 204, the physical activities performed by a user are determined as well as the remaining amount of physical activity. In a subsequent step 205, the physical activity to be performed by a user at the existing mode of transport and the second mode of transport in moving to the destination is calculated, and in step 206 a suggestion on a location for switching from the existing mode of transport to the second mode of transport on the basis of the previous steps is provided. The method ends in step 207.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

In short, the invention relates to a navigational unit 10 and a navigational device 50 for providing suggestions for switching mode of transportation. This may be used e.g. for suggesting car drivers to park at a reasonable distance of their destination such that the last part of their trip can be walked or cycled. By using information on a personal activity goal, performed activity, and possibly desired arrival time, a feasible and tailored suggestion can be given. In this way the time for transport and physical activity may be balanced.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A navigational unit (10) for providing directions on how to navigate to a destination, said navigational unit (10) being arranged to receive position information relating to the actual position of the navigational unit (10), and wherein the navigational unit (10) is arranged for providing a suggestion on a location for switching from an existing mode of transport to a second mode of transport, and where the suggestion is determined on the basis of a physical activity goal of a user and a calculation of the physical activity to be performed by the user at the existing mode of transport and/or at the second mode of transport in moving to the destination.

2. A navigational unit (10) according to claim 1, wherein the calculation of the physical activity to be performed takes into account the physical activity to be performed by a user, at the existing mode of transport, until the suggested location for switching mode of transport and the physical activity to be performed by the user, at the second mode of transport, from the suggested location for switching mode of transport to the destination.

3. A navigational unit (10) according to claim 1, wherein the physical activity goal is indicated in energy consumption or in time duration.

4. A navigational unit (10) according to claim 1 wherein the navigational unit moreover is arranged for receiving a signal from an activity monitor (22) arranged for monitoring the physical activity of a user.

5. A navigational unit (10) according to claim 1, wherein the suggestion on a location for switching is determined on the basis of a desired arrival time at the destination.

6. A navigational unit (10) according to claim 1, wherein the suggestion on a location for switching is determined on the basis of a desired amount of physical activity to be performed by a user.

7. A navigational unit (10) according to claim 1, wherein information of physical activity already performed within a specific span of time is taken into account in providing suggestion on a location for switching.

8. A navigational unit (10) according to claim 1, wherein the suggestion on a location for switching is determined on the basis of a special route to be covered by the user in moving to the destination at the second mode of transport.

9. A navigational unit (10) according to claim 1 wherein the existing mode of transport is a car and said location for switching is a parking lot.

10. A navigational unit (10) according to claim 1 wherein the existing mode of transport is a means of public transportation and said location for switching is a stop for the means of public transportation.

11. A navigational device (50), comprising a navigational unit (10) according to claim 1, a storage medium (12) and a satellite navigational module (14).

12. A route planner system (100) for navigating to a destination, comprising a navigational device (50) according to claim 11 and a personal activity program module (20).

13. A route planner system (100) according to claim 12, further comprising an activation monitor (22).

14. A method (200) of navigating to a destination, comprising the steps of:
receiving (202) position information relating to the actual position of a user
receiving (203) information on a physical activity goal of a user,
determining (204) the physical activities performed by a user at the existing mode of transport and at a second mode of transport,
calculating (205) the physical activity to be performed by a user at the existing mode of transport and the second mode of transport in moving to the destination, and
providing (206) a suggestion on a location for switching from the existing mode of transport to the second mode of transport on the basis of the previous steps.

15. A computer program product being adapted to enable a computer system comprising at least one computer having data storage means associated therewith to control a navigational unit according to claim 1.
